(19) United States
(12) Patent Application Publication
(10) Pub. No.: US 2016/0207432 A1
(43) Pub. Date: Jul. 21, 2016

(54) VEHICLE SEAT COVER SYSTEM

(71) Applicants: Hwa Cheng Teoh, Kuala Lumpur (MY); Chee Keng Sam, Kuala Lumpur (MY); Chen Xiang Wong, Kuala Lumpur (MY)

(72) Inventors: Hwa Cheng Teoh, Kuala Lumpur (MY); Chee Keng Sam, Kuala Lumpur (MY); Chen Xiang Wong, Kuala Lumpur (MY)

(21) Appl. No.: 15/087,332

(22) Filed: Mar. 31, 2016

Related U.S. Application Data
(63) Continuation-in-part of application No. 13/256,970, filed on Sep. 16, 2011.

(30) Foreign Application Priority Data
Mar. 18, 2009 (MY) PI 20091094

(51) Int. Cl. B60N 2/60

(52) U.S. Cl. CPC B60N 2/6027

(57) ABSTRACT

A vehicle seat cover arrangement comprising a vehicle seat having an outer surface, an interchangeable vehicle seat cover having an inner surface integrally made from a plush-like material with a loops-like structure, and a sheet-like attachment means having a hooks-like surface and attached on to the outer surface of the vehicle seat, wherein the seat cover is closely fitted on to the vehicle seat by engagement between the loops-like structure and the hooks-like surface.

### CROSS-REFERENCE TO RELATED APPLICATION

The instant application is a continuation-in-part of U.S. patent application Ser. No. 13/256,970 filed Sep. 16, 2011, pending, which is a national phase of PCT International Application No. PCT/MY2009/000063, filed on May 26, 2009, and which claims priority to Malaysian Patent Application No. P1 20091094, filed Mar. 18, 2009, the entire specifications of all of which are expressly incorporated herein by reference.

### FIELD OF INVENTION

This invention relates to a vehicle seat cover arrangement. More particularly, the present invention relates to a method of fast and closely attaching and fitting an interchangeable vehicle seat cover onto a vehicle seat.

### BACKGROUND OF INVENTION

Conventionally, the outer surface of vehicle seats is usually made from fabric, or leather in some high end vehicle. Fabric vehicle seats are cheap and durable which can withstand as much beating as possible. However, one of the drawbacks of using fabric for the vehicle seats is that fabric is prone to be stained especially when one accidentally pours colored liquid on it. The outer appearance of the fabric vehicle seats deteriorates through time. In order to solve the aforementioned problem, a protective vehicle seat cover is used to protect the seat fabric and cushion as well as to improve the outer appearance of the vehicle seat.

The use of the vehicle seat cover can be provided by the vehicle manufacturer or the end user thereof. Vehicle seat cover is a great idea to prevent deleterious factors such as spilt dirt, wetness, friction or harsh sunlight from destroying the vehicle seats and thus increasing its durability. In addition, the interchangeability of a vehicle seat cover is vital to promote hygiene in the internal environmental of the vehicle. Besides, it allows various designs of the vehicle seat covers for accommodating different lifestyles of a user.

In a conventional vehicle seat cover system, a vehicle seat cover is fitted to the vehicle seat by various fastening means including a belt structure with buckles, straps, a double-sided adhesive, a hook-and-loop fastener, or a combination thereof. Most currently available vehicle seat cover designs aim to ease the engagement and disengagement of the vehicle seat cover but this is compromised by a loose-fit between the vehicle seat cover and the vehicle seat. The position of the vehicle seat cover has to be adjusted from time to time to ensure the vehicle seat cover is in place.

Further, the existing of air pockets between the vehicle seat cover and the vehicle seat due to the loose fit provides uncomfortable experience to the driver and passengers. Comfortability of the vehicle seat is important as a comfortable vehicle seat can promote driving safety. In order to enhance the level of comfortability of a vehicle seat, a close fit between the seat cover and the seat is desirable. Nevertheless, a close fit between the vehicle seat cover and the vehicle seat cannot be realized without complicated and time-consuming procedures and arrangement.

In view of the drawbacks of the existing technology, there is a need to develop an improved vehicle seat cover system or arrangement which can attach a vehicle seat cover firmly onto a vehicle seat without a complicated and time-consuming procedure or method. This method shall be easy, convenient, and create minimal effect on the texture of the original cushion or fabric layer of the vehicle seat.

### SUMMARY OF INVENTION

One of the objects of the invention is to closely fit a vehicle seat cover onto a vehicle seat to get a close fit therebetween for preventing any twist and turn of the seat cover during a driving journey.

Another object of the invention is to provide a closely fit vehicle seat cover system or arrangement with minimal effect on the original cushion or fabric layer of the vehicle seat.

Still another object of the invention is to provide a simple and fast fitting vehicle seat cover system or arrangement which can also provide a close fit between the vehicle seat cover and the vehicle seat.

Yet another object of the invention is to provide a method for attaching a vehicle seat cover onto a vehicle seat which is simple and convenient for allowing interchangeability of various designs of the vehicle seat covers.

Again another object of the present invention is to provide an interchangeable vehicle seat cover which can be closely attached onto the vehicle seat to give a better appearance to the vehicle seat and a more comfortable support to the driver or passenger of the vehicle at the backrest and seat base portion.

Also another object of the present invention is to provide a vehicle seat cover which can be of various designs and comparable in quality yet low in production cost.

At least one of the preceding aspects is met, in whole or in part, by the present invention, in which the embodiment of the present invention describes a vehicle seat cover arrangement comprising a vehicle seat having an outer surface, an interchangeable vehicle seat cover having an inner surface integrally made from a plush-like material with a loops-like structure, and a sheet-like attachment means having a hooks-like surface and attached on to the outer surface of the vehicle seat, wherein the seat cover is closely fitted on to the vehicle seat by engagement between the loops-like structure and the hooks-like surface.

Preferably, the attachment means spans at least a fitting line transversely of the vehicle seat.

A further embodiment of the invention is a vehicle seat cover arrangement comprising a vehicle seat having an outer surface integrally made from a plush-like material with a loops-like structure; an interchangeable vehicle seat cover having an inner surface; and a sheet-like attachment means having a hook-like surface and attached on to the inner surface of the seat cover, wherein the seat cover is closely fitted on to the vehicle seat by engagement between the loops-like structure and the hooks-like surface.

Preferably, the attachment means is positioned in such a way that spans at least a fitting line transversely of the vehicle seat when the seat cover is closely fitted on to the vehicle seat.

Preferably, the plush-like material is a knit fabric. The seat cover may comprise a backrest cover and a seat base cover, and preferably the backrest cover and the seat base cover are separate pieces.

The preferred embodiment of the invention consists of novel features and a combination of parts hereinafter fully described and illustrated in the accompanying drawings and particularly pointed out in the appended claims; it being understood that various changes in the details may be effected by those skilled in the arts but without departing from the scope of the invention or sacrificing any of the advantages of the present invention.

### BRIEF DESCRIPTION OF THE DRAWINGS

For the purpose of facilitating an understanding of the invention, there is illustrated in the accompanying drawing the preferred embodiments from an inspection of which when considered in connection with the following description, the invention, its construction and operation and many of its advantages would be readily understood and appreciated.

FIG. 1 is a perspective view of a vehicle seat as embodied by one of the preferred embodiments of the invention;

FIG. 2 shows a method of attaching a backrest vehicle seat cover to a backrest of a vehicle seat as embodied by one of the preferred embodiments of the invention and

FIG. 3 shows a method of attaching a seat base vehicle seat cover to a seat base of a vehicle seat as embodied by one of the preferred embodiments of the invention.

The same reference numerals refer to the same parts throughout the various figures.

### DETAILED DESCRIPTION OF THE INVENTION

The following description of the preferred embodiment(s) is merely exemplary in nature and is in no way intended to limit the invention, or uses.

This invention relates to a vehicle seat cover arrangement. More particularly, the present invention relates to a method of fast and closely attaching and fitting an interchangeable vehicle seat cover onto a vehicle seat.

Hereinafter, the invention shall be described according to the preferred embodiments of the present invention and by referring to the accompanying description and drawings. However, it is to be understood that limiting the description to the preferred embodiments of the invention and to the drawings is merely to facilitate discussion of the present invention and it is envisioned that those skilled in the art may devise various modifications without departing from the scope of the appended claim.

The invention discloses a vehicle seat cover arrangement comprising: a vehicle seat (1) having an outer surface; an interchangeable vehicle seat cover (2) having an inner surface integrally made from a plush-like material with a loops-like structure; and a sheet-like attachment means (15) having a hooks-like surface and attached on to the outer surface of the vehicle seat (1), wherein the seat cover (2) is closely fitted on to the vehicle seat (1) by engagement between the loops-like structure and the hooks-like surface.

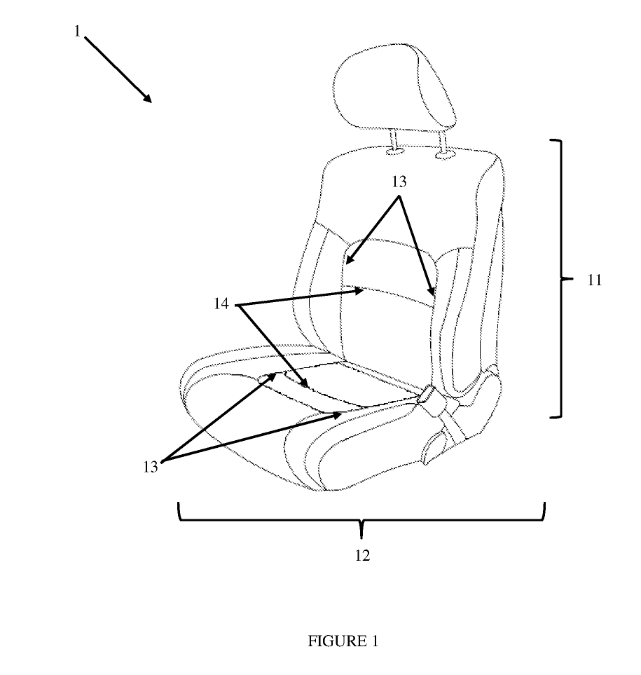

As shown in FIG. 1, a typical seat vehicle seat (1) covered with a factory-fitted cover comprises a backrest (11) and a seat base (12). The factory-fitted cover refers to the basic or original cover which has been readily attached to the outer surface of the backrest (11) or the seat base (12) of a vehicle seat during the manufacturing process of the vehicle seat (1). The factory-fitted cover can be made of fabric, polyvinylchloride (PVC), or leather. On the backrest (11) or the seat base (12), a plurality of fitting lines (13, 14) are provided to render the shape of the vehicle seat (1), particularly the surface where one will sit or lie on, sufficiently supportive for one to sit on, apart from aiming to improve outer appearance of the vehicle seat (1). Typically, the fitting lines (13, 14) include two vertical fitting lines (13) at two opposed sides of the vehicle seat (1) and a transverse fitting line (14) across the two vertical fitting lines (13), in which the two ends of the transverse fitting line (14) is along the vertical fitting lines (13). There may be more than one transverse fitting line (14), however, only one of which is most vital to provide sufficient support to one's weight.

According to the preferred embodiment of the invention, an interchangeable vehicle seat cover (2) having a corresponding shape, contour, and fitting lines of the vehicle seat (1) is provided. The inner surface (21) of the vehicle seat cover (2) is integrally made from a plush-like material (22) which has a surface with a plurality of loops or a loops-like structure. Preferably, the plush-like material (22) is a knit fabric and more preferably, the knit fabric is brushed tricot fabric. However, the plush-like material (22) described herein is not referred to as the loop fastener of VELCRO™, as VELCRO™ is neither elastic nor stretchable, both of these properties being preferred in the present invention. Since no additional attachment means is needed to be attached to the inner surface (21) of the vehicle seat cover (2), one can experience a softer and smoother feeling of the vehicle seat cover, with minimal bulging feel, when in use. Further, the plush-like material (22) is more durable than the VELCRO™ loop fastener and permits multiple attachment and detachment with minimal damage to the plush-like material (22).

Although it is not shown in any of the accompanying drawings, the entire inner surface (21) of the vehicle seat cover (2) may be integrally made from the plush-like material (22) for ease of manufacturing. However, it is not necessary to provide the plush-like material (22) for the entire inner surface (21) of the vehicle seat cover (2). The area and position of the plush-like material (22) shall be sufficient to cover a sheet-like attachment means (15) attached on the vehicle seat (1). Preferably, only the centre portion of the inner surface (21) of the vehicle seat cover (2) is made from plush-like material (22) which is sufficient to cover the attachment means (15) on the vehicle seat (1) and with acceptable ease of manufacturing.

As described by the preferred embodiment of the invention, a sheet-like attachment means (15) is attached on to at least a portion of the outer surface of the vehicle seat (1). The attachment means (15) has a hooks-like surface to engage with the loops-like structure of the plush-like material (22) of the vehicle seat cover (2). The attachment means (15) can be like VELCRO™, or any other material having a surface with a plurality of hooks which can penetrate within the loops-like structure of the plush-like material (22) for engagement. Preferably, the hooks are configured in such a way which causes minimal damage to the plush-like material (22) without compromising with the engagement performance. However, the attachment means (15) can be replaced by any fastening means, such as a sheet-like material with at least an adhesive surface, which can engage with the plush-like material (22) and provide a similar engagement performance.

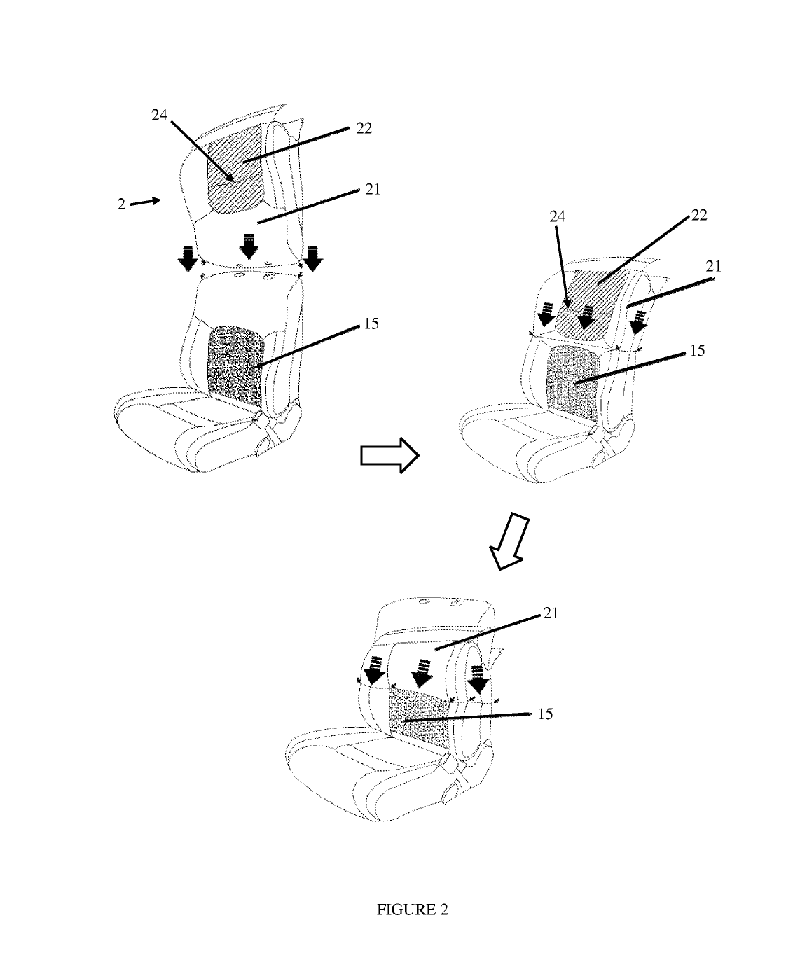

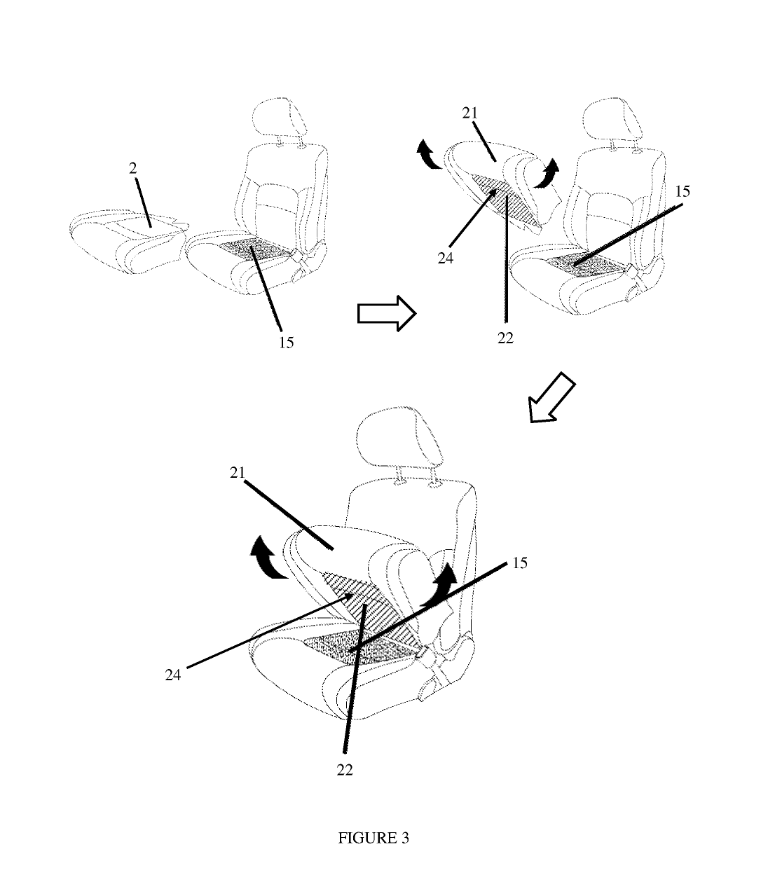

Although it is not shown in any of the accompanying drawings, the attachment means (15) may be attached on the entire outer surface of the vehicle seat (1). However, it is not necessary to cover the entire outer surface of the vehicle seat (1) with the attachment means (15) for a sufficiently strong engagement and close fitting of the vehicle seat cover (2). Preferably, the attachment means (15) shall at least span the transverse fitting line (14) of the vehicle seat (1). More preferably, the attachment means (15) spans the centre portion of the outer surface of the vehicle seat (1) which also overlaps the transverse fitting (14), as shown in FIGS. 2 and 3. The attachment means (15) can be attached to the vehicle seat (1) by any attachment method, but preferably by an adhesive back surface of the attachment means (1) which causes minimal damage to the factory-fitted cover so that the attachment means (15) can be detached if one would decide not to use any vehicle seat cover (2) in the future.

In accordance with the preferred embodiment of the invention, the vehicle seat cover (2) which is interchangeable is closely fitted on to the vehicle seat (1) by engagement between the loops-like structure of the plush-like material and the hooks-like structure of the attachment means. Particularly, the loops of the plush-like material (22) of the inner surface (21) of the vehicle seat cover (2) engage with the attachment means (15) attached onto the outer surface of the vehicle seat (1). More particularly, corresponding transverse fitting line (24) on the vehicle seat cover (2) is aligned with the transverse fitting line (14) on the vehicle seat (1) to form a close fit, and the rest of the vehicle seat cover (2) conforms to the entire contours of the vehicle seat (1).

An exemplary procedure for assembling the vehicle seat cover (2) to a vehicle seat (1) is shown in FIGS. 2 and 3. The cover (2) can be fixed onto the backrest (11) or the seat base (12) of the vehicle seat (1) by turning the cover (2) inside out as shown in FIGS. 2 and 3, and attaching its inner surface (21) onto the outer surface of the vehicle seat (1) on which the attachment means (15) has been attached to. The attachment means (15) on the vehicle seat (1) will attach to the plush inner surface (22) of the vehicle seat cover (2). The corresponding transverse fitting line (24) on the vehicle seat cover (2) is aligned with the transverse fitting line (14) on the vehicle seat (1) to form a close fit. Trapped air can be eliminated by gently pressing the cover (2) onto the seat (1) to obtain a close fit between the cover (2) and the vehicle seat (1).

As depicted in the preferred embodiment of the invention, the vehicle seat cover (2) comprises two parts, which are a backrest cover and a seat base cover. The backrest cover and the seat base cover may be a one-piece article or two separate pieces of articles, and the latter is preferred. The vehicle seat cover (2) can be made of various types of materials, such as waterproof neoprene, stain-resistant polyester or cotton, velour, leather, sheepskin or a combination of any two of more thereof. In the present invention, the most preferred materials used are leather and PVC.

Although it is not fully illustrated in any of the accompanying drawings, a further embodiment of the invention is a vehicle seat cover arrangement comprising: a vehicle seat (1) having an outer surface integrally made from a plush-like material with a loops-like structure; an interchangeable vehicle seat cover (2) having an inner surface; and a sheet-like attachment means (15) having a hook-like surface and attached on to the inner surface of the seat cover (2), wherein the seat cover (2) is closely fitted on to the vehicle seat (1) by engagement between the loops-like structure and the hooks-like surface.

In another preferred embodiment of the invention, a factory-fitted cover of a vehicle seat (1) may be integrally made from the plush-like material with a plurality of loops or a loops-like structure. Particularly, at least a portion of the factory-fitted cover of the vehicle seat (1) may be made from the plush-like material. Preferably, at least the centre portion of the factory-fitted cover of the vehicle seat (1), where the transverse fitting line (14) is positioned therewithin, may be made from the plush-like material. However, the plush-like material described herein is not referred to as the loop fastener of VELCRO™, as VELCRO™ is neither elastic nor stretchable, both of these properties being preferred in the present invention. Since no additional attachment means is needed to be attached to the outer surface (21) of the vehicle seat cover (2), one can experience a softer and smoother feeling of the vehicle seat cover, with minimal bulging feel, when in use. Further, the plush-like material is more durable than the VELCRO™ loop fastener and permits multiple attachment and detachment with minimal damage to the plush-like material.

Still in another preferred embodiment of the invention, an interchangeable vehicle seat cover (2) having a corresponding shape, contour, and fitting lines of the vehicle seat (1) is provided. A sheet-like attachment means (15) is attached on to the inner surface (21) of the vehicle seat cover (2). The attachment means can be like VELCRO™, or any other material having a surface with a plurality of hooks which can penetrate within the loops of the plush-like material for engagement. Preferably, the hooks are configured in such a way which causes minimal damage to the plush-like material without compromising with the engagement performance. It is also not necessary to attach the attachment means for the entire inner surface (21) of the vehicle seat cover (2). The area and position of the hook-like fastener shall be sufficient to cover the plush-like outer surface of the vehicle seat (1). Preferably, the hooks-like surface of the attachment means (15) is positioned in such a way that spans at least a fitting line transversely (14) of the vehicle seat (1) when the seat cover (2) is closely fitted on to the vehicle seat (1). More preferably, only the centre portion of the inner surface of the vehicle seat cover (2) is attached with the attachment means which is sufficient to cover the plush material on the vehicle seat (1) and with acceptable ease of manufacturing. However, the attachment means can be replaced by any fastening means, such as a sheet-like material with at least an adhesive surface, which can engage with the plush-like material and provide a similar engagement performance.

Again in another preferred embodiment of the invention, the vehicle seat cover (2) which is interchangeable is closely fitted on to the vehicle seat (1) by engagement between the loops-like structure of the plush-like material of the vehicle seat (1) and the hook-like surface of the attachment means. Particularly, the loops of the plush-like material on the outer surface of the vehicle seat (1) engage with the hooks of the attachment means (15) on the inner surface of the vehicle seat cover (2). More particularly, corresponding transverse fitting line (24) on the vehicle seat cover (2) is aligned with the transverse fitting line (14) on the vehicle seat (1) to form a close fit, and the rest of the vehicle seat cover (2) conforms to the entire contours of the vehicle seat (1). Likewise, the vehicle seat cover (2) comprises two parts, which are a backrest cover and a seat base cover. The backrest cover and the seat base cover may be a one-piece article or two separate pieces of articles, and the latter is preferred.

Although the invention has been described and illustrated in detail, it is to be understood that the same is by the way of illustration and example, and is not to be taken by way of limitation. The spirit and scope of the present invention are to be limited only by the terms of the appended claims.

What is claimed is:

1. A vehicle seat cover arrangement, comprising:
a vehicle seat having an outer surface;
an interchangeable vehicle seat cover having an inner surface integrally made from a plush-like material with a loops-like structure; and
a sheet-like attachment means having a hooks-like surface and attached on to the outer surface of the vehicle seat;
wherein the seat cover is closely fitted on to the vehicle seat by engagement between the loops-like structure and the hooks-like surface.

2. The arrangement according to claim 1, wherein the attachment means spans at least a fitting line transversely of the vehicle seat.

3. The arrangement according to claim 1, wherein the plush-like material is a knit fabric.

4. The arrangement according to claim 1, wherein the seat cover comprises a backrest cover and a seat base cover.

5. The arrangement according to claim 1, wherein the backrest cover and the seat base cover are separate pieces.

6. A vehicle seat cover arrangement, comprising:
a vehicle seat having an outer surface integrally made from a plush-like material with a loops-like structure;
an interchangeable vehicle seat cover having an inner surface; and
a sheet-like attachment means having a hook-like surface and attached on to the inner surface of the seat cover;
wherein the seat cover is closely fitted on to the vehicle seat by engagement between the loops-like structure and the hooks-like surface.

7. The arrangement according to claim 6, wherein the attachment means is positioned in such a way that spans at least a fitting line transversely of the vehicle seat when the seat cover is closely fitted on to the vehicle seat.

8. The arrangement according to claim 6, wherein the plush-like material is a knit fabric.

9. The arrangement according to claim 6, wherein the seat cover comprises a backrest cover and a seat base cover.

10. The arrangement according to claim 6, wherein the backrest cover and the seat base cover are separate pieces.
